(19) United States
(12) Patent Application Publication
(10) Pub. No.: US 2005/0140335 A1
(43) Pub. Date: Jun. 30, 2005

(54) Equalizer for series of connected battery strings

(76) Inventors: Chun-Hsien Lee, Chang-Hua City (TW); Pao-Chuan Lin, Chu-Pei (TW)

Correspondence Address: BIRCH STEWART KOLASCH & BIRCH, PO BOX 747, FALLS CHURCH, VA, 22040-0747, US

(21) Appl. No.: 10/882,172

(22) Filed: Jul. 2, 2004

(30) Foreign Application Priority Data
Dec. 31, 2003 (TW) 092137829

(51) Int. Cl. H02J 7/00

(52) U.S. Cl. 320/118

(57) ABSTRACT

A terminal voltage equalization circuit is used to equalize the terminal voltage of the series of connected battery strings so that each battery in the series of connected battery strings can be equally charged. When voltage of a certain battery in the battery string is higher than that of the other batteries, the battery voltage sensing and controlling circuit will output a high frequency signal to drive the switch devices to transit power from the high voltage batteries to the low voltage batteries by transformer. By the high switching switches, the charging currents through the batteries with high terminal voltages can be reduced, the charging currents through the batteries with low terminal voltages can be enhanced, and therefore the damages to the batteries due to overcharging can be avoided and speedy balance of the terminal voltages between each battery can be achieved.

### BACKGROUND OF THE PRESENT INVENTION

1. Field of the Invention

The invention generally relates to an energy equalization circuit for a battery charger, and more particularly to an equalization circuit for balancing the terminal voltages of each battery.

2. Description of the Prior Art

It is often needed to cascade many batteries in a series of connected battery strings in practice, for example, the electric motorcycle needs four Lead-Acid batteries and the electric bicycle needs two or three Lead-Acid batteries to compose a series of connected battery strings, therefore whether the state of charge, capacity, and characteristic of each battery match for each other is extraordinarily important in the series of connected battery strings. Besides, since the state of charge of each battery in the series of connected battery strings varies as the using times increase and according to whether it matches for other batteries in the series of connected battery strings, and the state of charge of the batteries in the series of connected battery strings is hard to measure, therefore the difference between the terminal voltages of each battery in the battery strings increases and the batteries with higher level/amount of state of charge are more easily damaged due to being overcharged. Hence, each battery in the series of batteries can operate under the best conditions by appropriately sensing and adjusting the situation of a single battery, for example, balancing the terminal voltages between each battery in the series of connected battery strings when there is difference between the terminal voltages of each battery, and thus extending the life of the batteries, which is the main purpose of the equalizer.

FIG. 1 represents a conventional dissipative type equalizer constituted with resistors, wherein the series of connected battery strings is connected by three batteries B1, B2 and B3; and I represents a direct current source used to charge the series of batteries. Referring to FIG. 1, batteries B1, B2 and B3 are respectively connected with the by-pass circuits which are constituted by resistors R1, R2, R3 and switches S1, S2, S3. Furthermore, a battery voltage sensing and controlling circuit is used to control the operation of the equalizer. The battery voltage sensing and controlling circuit senses and controls the terminal voltages between batteries B1, B2, and B3 continuously while the battery string is being charged. Under the general principles, it is assumed that the battery B1 exceeds the battery B2 and B3 in terminal voltages. When the terminal voltage of battery B1 is detected to be higher than that of batteries B2 and B3 and over a predestinate value, the battery voltage sensing and controlling circuit will output a signal from P1 to turn on the switch device S1. At this time, the battery B1 and resistor R1 are in parallel connecting and let a part of charging current pass through the resistor R1 and reduce the current flowing through the Battery B1 (I_{B1}=I−_{R1}) Besides, the current flowing through the batteries B2 and B3 is still I. Hence, the rising rate of terminal voltage of battery B1 can be slowed down and the terminal voltage of each battery in the battery strings can gradually achieve balance.

The above-mentioned resistance type equalizer uses the shunt resistors to consume the imbalanced power between each battery in the series of connected battery strings. Therefore, more heat will be generated in the circuit and the efficiency will be lower, which shows that this type of equalizer is not economical.

FIG. 2 represents a non-dissipative type equalizer constituted with the transformers. The circuit structure in FIG. 2 is similar to that in FIG. 1, but three identical flyback type transformers T1, T2, T3 are used to substitute the resistors and high frequency signal generators are added in the battery voltage sensing and controlling circuit. Furthermore, the turn numbers of the secondary windings are the same, but the polarity of the secondary winding is opposite to that of the primary winding in all transformers. When the difference of the terminal voltages between battery B1 and batteries B2, B3 reaches a predetermined value, the battery voltage sensing and controlling circuit will output a high frequency signal from P1 to drive switch device S1 and then turn on and off continuously to let the primary winding of transformer T1 transfer energy to the secondary winding. The induced current then goes back to charging loop through the diode D1 to charge the series of battery strings. Thus, the rising rate of the terminal voltage of battery B1 can be slowed down and a balance between each battery of the battery strings can be gradually achieved, and the imbalanced power in battery B1 can also be recycled for using during the equalization process.

The method using the non-dissipative type transformer for equalizing potential of batteries can eliminate the problems of heat and low efficiency, etc. caused by the dissipative type resistance equalizer circuit. But a number of transformers equal to the number of batteries in the battery strings have to be used, and the volume and weight of transformers will increase the size and weight of the circuit greatly when many batteries have to be used to cascade a series of battery strings in practice.

Consequently, the non-dissipative type circuit of equalizer should be improved to obtain a smaller and more flexible circuit structure for accomplishing advantages such as less heat, high efficiency, small volume and light weight.

### SUMMARY OF THE PRESENT INVENTION

The problems in the above-mentioned techniques are more heat, low efficiency, large volume and heavy weight, therefore the present invention provides an equalization circuit for series of connected battery strings to ensure the batteries in the battery strings will operate under the best conditions.

Another main purpose of the present invention is to provide a forward type power transfer means for speedy equalizing effect by transferring the imbalanced energy from the batteries with high terminal voltages to the batteries with low terminal voltages directly during the process of equalization between each battery in the series of connected battery strings.

Still another main purpose of the present invention is to provide an equalizer for the series of connected battery strings to reduce total volume of the transformers in the circuit effectively and to reduce the size and weight of the whole circuit substantially.

The present invention includes a transformer, which is constituted by a primary winding and a secondary winding, the primary windings have the same number of windings and the identical polarity, the number of winds of the secondary winding being identical to the sum of the number of windings of the primary winding; and a switch means, which is constituted by a plurality of switch components, each of the switch component connecting with the plurality of windings in the primary winding in identical polarity, when the plurality of switch components being turned on simultaneously by a control signal, the plurality of windings in the primary winding become a primary winding and a secondary winding to each other individually.

### BRIEF DESCRIPTION OF THE DRAWINGS

FIG. 1 is a circuit diagram of the dissipative type equalizer of the series of connected battery strings.

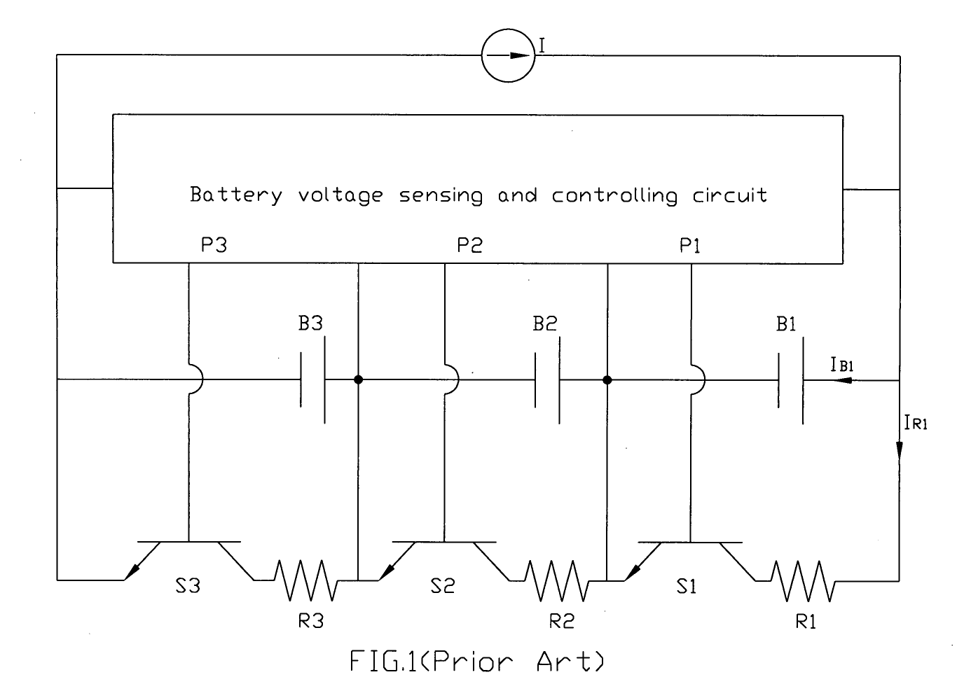

FIG. 2 is a circuit diagram of the non-dissipative type equalizer of the series of connected battery strings.

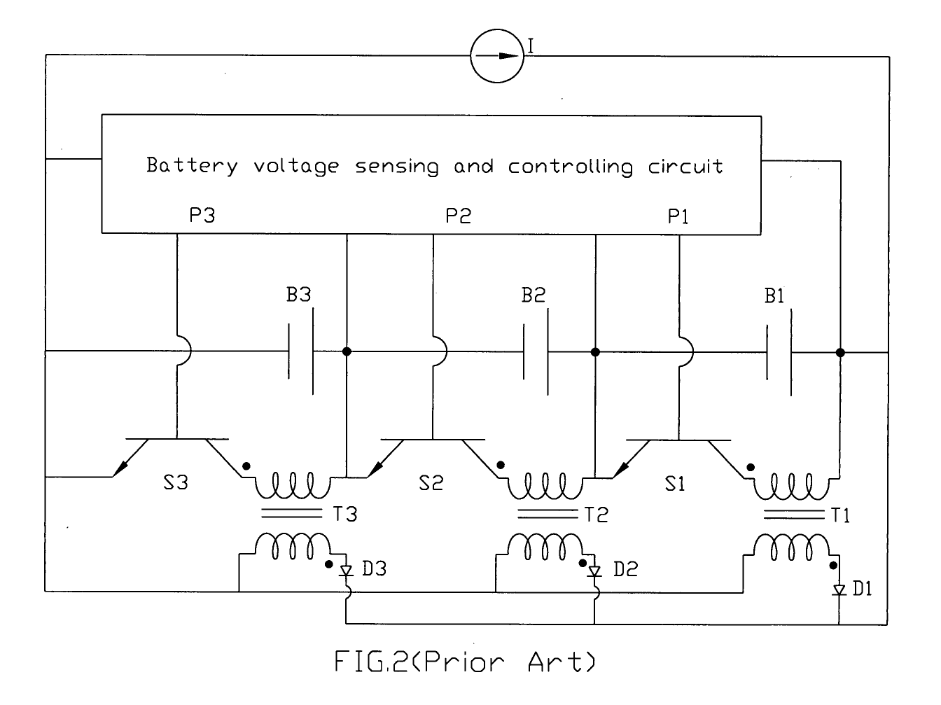

FIG. 3 is a function block diagram of an embodiment of the present invention.

FIG. 4 is a circuit diagram of an embodiment of the present invention.

FIG. 5 is a circuit diagram of an embodiment of the present invention.

### DESCRIPTION OF THE PREFERRED EMBODIMENT

The following descriptions of the circuit of present invention do not include the complete structure of the equalizer. It just quotes the key points of traditional techniques to illustrate the present invention. Moreover, all of the drawings related to the present invention are not made according to the scales, and they are just used to represents the characteristics of structure of present invention.

The present invention includes a transformer means, which is constituted by a primary winding and a secondary winding, the primary winding being constituted by a plurality of windings with the identical number of windings and the identical polarity, the number of windings of the secondary winding being identical to the sum of the number of windings of the primary winding; and a switch means, which is constituted by plurality of switch components, each of the switch component connecting with a plurality of windings in primary winding in identical polarity, when a plurality of switch components being turned on simultaneously by a control signal, the plurality of windings in the primary winding become a primary winding and a secondary winding to each other individually.

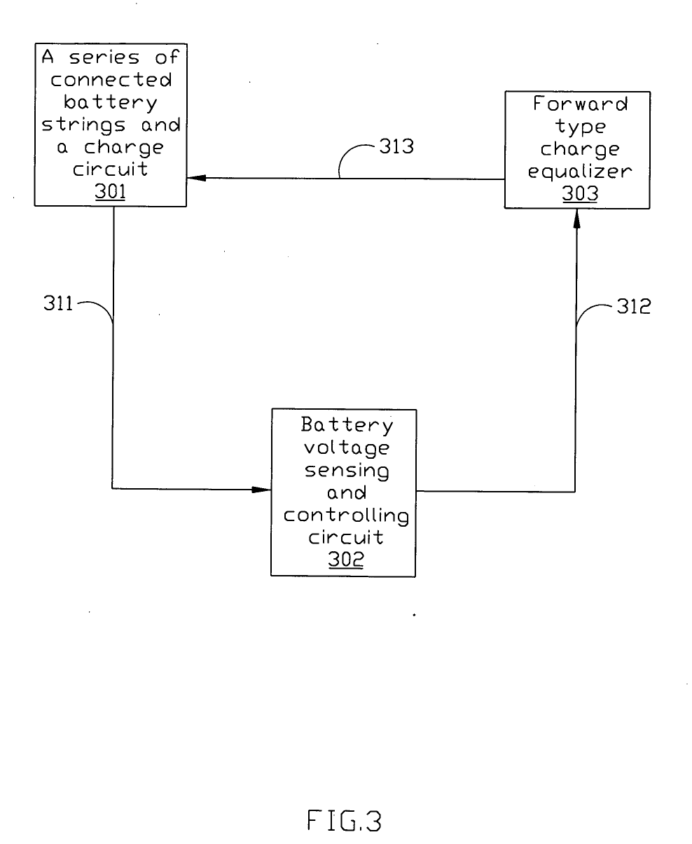

FIG. 3 shows a function block diagram of an embodiment of the present invention. Block 301 includes a series of connected battery strings and a charge circuit. The terminal voltages of batteries in the series of connected battery strings are sensed by the battery voltage sensing and controlling circuit in block 302 via wires 311 to sense whether the difference in terminal voltages between any two batteries is normal. Block 301 will maintain the charging process when the difference in terminal voltages between any two batteries is regular. Otherwise, when the difference in terminal voltages between any two batteries is irregular, that means the terminal voltages of a certain battery in the series of connected battery strings is too high or too low, then the battery voltage sensing and controlling circuit in block 302 will output a high frequency signal via wires 312 to drive the equalization circuit in block 303, and equalize the energy of each battery in the series of connected battery strings in block 301 via wires 313. At the same time, block 302 is still sensing the terminal voltages of each battery in the series of connected battery strings in block 301 via wires 311. It outputs the high frequency signal via wires 312 to drives block 303 continuously to maintain the equalization process of the terminal voltages of each battery in the series of connected battery strings when the difference in the terminal voltages between each battery is still irregular. Otherwise, the battery voltage sensing and controlling circuit in block 302 will stop outputting the high frequency signal via wires 312 for stopping the equalization process in block 301 when the difference in the terminal voltages between each battery recovers, then the circuit returns to regular charge mode.

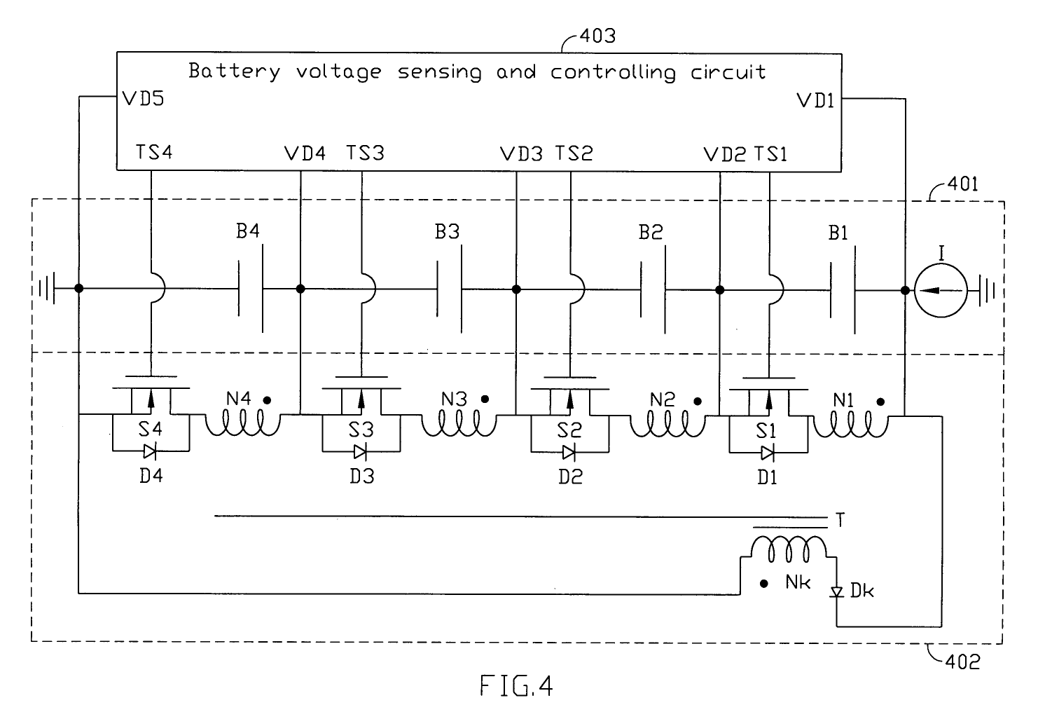

FIG. 4 is a circuit block diagram of the equalizer of an embodiment of the present invention. Block 401 is a series of connected battery strings constituted with a current source and a plurality of batteries, the current source is a direct current source I and the series of connected battery strings is composed by four series of connected batteries B1, B2, B3 and B4 in this embodiment. The positive terminal of current source I connects with the positive terminal of battery B1 and the negative terminal of current source I connects with the negative terminal of battery B4. Block 402 is a battery voltage sensing and controlling circuit, which utilizes a micro-controller with five input ports VD1, VD2, VD3, VD4, VD5 for sensing the terminal voltages of batteries B1, B2, B3, B4 individually and four output ports TS1, TS2, TS3, TS4 for outputting the driving signal to the switching components in block 403 (e.g. three terminal device such as field effect transistor) in this embodiment, wherein it has an individual driving signal or the same driving signal from output ports TS1, TS2, TS3, TS4 to control switching components S1, S2, S3, S4. Block 403 is an equalization circuit constituted with a transformer T, four identical high frequency switching components S1, S2, S3, S4 and five identical two terminal devices (e.g. diode or the internal parasitism diode of the field effect transistor) D1, D2, D3, D4, Dk for forming a loop. The windings N1, N2, N3, N4 of the transformer T all have the same number and polarity (e.g. the dot end symbolizes positive end, the opposite end is negative end), and can become a primary or secondary winding dependent on the status of the switched component. Therefore transformer T is a forward type transformer. The number of windings of another internal winding Nk of forward type transformer can be determined by the number of batteries in the battery strings. There are four batteries with corresponding four windings N1, N2, N3, N4 in this embodiment, therefore the number of winding Nk is four times of the number of winding N1. The polarity of winding Nk is opposite to winding N1.

In FIG. 4, battery voltage sensing and controlling circuit won't output the high frequency signal under the regular charge mode. At that time, equalization circuit 403 is in static situation (i.e. haven't any current flow through) because there is not any signal to trigger switches S1, S2, S3, S4, which makes switches S1, S2, S3, S4 all in “off” status. Hence, all of the current from direct current source I will flow through the series of connected battery strings. When battery voltage sensing and controlling circuit 402 discovers that the terminal voltages of a certain battery in the battery strings (e.g. battery B1) is higher than the others (e.g. the terminal voltages of battery B2, B3, B4) to a predetermined value (e.g. 0.3 voltage), then output port TS1 will output a high frequency signal to trigger switch S1. The Pulse-Width-Modulated (PWM) signal is the high frequency signal in this embodiment, thus switch S1 can be turned on and off.

As the above-mentioned, transformer T becomes a forward type transformer immediately when switch S1 is driven. At that time, winding N1 becomes a primary winding in transformer T and windings N2, N3, N4 become the secondary windings by induction. The currents are induced from winding N2 flows from positive end into the positive terminal of battery B2 for charging and then flow out from the negative terminal of battery B2 to turns on diode D2 for forming a loop. The charging currents of battery B2 are the sum of the currents from direct current source I and the induced currents from winding N2. Thus, the purpose of charging battery B2 by the imbalanced voltages from battery B1 can be achieved. Furthermore, it can also promote the charging current of battery B2 by controlling the duty cycle of the Pulse-Width-Modulated (PWM) signals to adjust the magnitude of the induced currents.

Similarly, the currents induced from windings N3, N4 and charging batteries B3, B4 respectively can also advance the charging effect. The utilization of the forward type transformer in present invention not only makes use of imbalanced power of battery B1 to advance the charging effect in the other batteries, but also speedily reduces the difference in voltages between each battery by restraining the charging rate in battery B1. Naturally, when an irregular condition occurs to the terminal voltages of one or more batteries in the series of connected battery strings, equalization circuit 403 will draw out the currents of these batteries to charge the other batteries. Besides, the magnetizing energy stored in transformer T will be drained out by the induced currents from winding Nk and flow back to the battery string through diode Dk when the switch component is turned off, thus the charging currents flowing to the series of connected battery strings can also be increased, but the main purpose of that is to demagnetize the iron core in transformer T. It is a principle to those skills in the transformer art.

In the same embodiment, when the battery voltage sensing and controlling circuit determinates the difference in voltages between battery B1 and the other batteries in the battery strings recovers from over a predetermined value during the operation of equalization circuit 403, the Pulse-Width-Modulated (PWM) signals from output port TS1 will be stopped. At that time, switch S1 is turned off, the operation of equalization circuit 403 is stopped and only the operation of current source I remains to charge batteries B1, B2, B3.

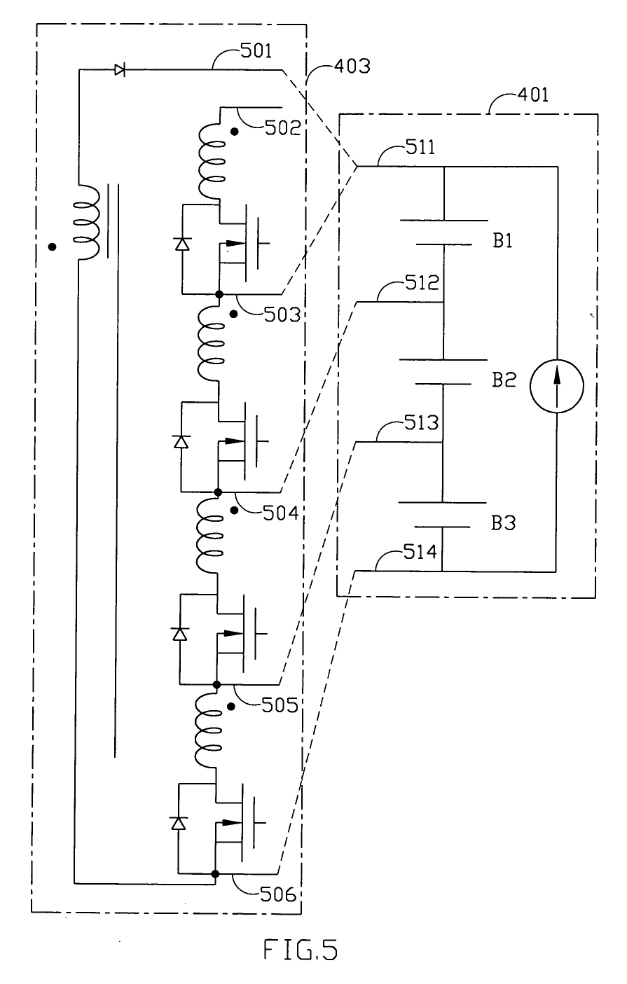

FIG. 5 shows another preferred embodiment of the present invention. There are four equalization loops and just three batteries B1, B2, B3. Wire 501 and wire 511, wire 503 and wire 511, wire 504 and wire 512, wire 505 and wire 513, wire 506 and wire 514 should be connected, and then wire 520 should be floating, thus the circuit can operate regularly. Similarly, when there are just batteries B1, B2 in the battery string, wire 501 and wire 511, wire 504 and 511, wire 505 and wire 512, wire 506 and wire 513 should be connected, and then floats wire 502, wire 503 and wire 514, thus the circuit can operate regularly. It can be seen that the equalization circuit in present invent can work in different quantity of batteries by different wire connected, which benefits the modularity of the equalization circuit and increases the applications.

The series of connected battery strings can be utilized in electric bicycles, electric motorcycles, electric automobiles or the other apparatuses powered by battery. The present invention can be used in any apparatus flexibly and makes the operation of series of connected battery strings under the best conditions for increasing the efficiency and life of batteries.

What are described above are only preferred embodiments of the invention, not for confining the claims of the invention; and for those who are familiar with the present technical field, the description above can be understood and put into practice, therefore any equal-effect variations or modifications made within the spirit disclosed by the invention should be included in the appended claims.

1. A equalizer, wherein said equalizer comprising:
a transformer, which is constituted by a primary winding and a secondary winding, said primary winding being constituted by a plurality of windings with the identical number of windings and the identical polarity, the number of windings of said secondary winding being identical to the sum of the number of windings of said primary winding; and
a switch means, said switch means is constituted by a plurality of switch devices, each of said switch devices of said switch means being coupled with said plurality of windings in identical polarity separately in said primary winding; wherein
when said plurality of switch devices being driven by a control signal simultaneously, said plurality of winding in said primary winding becoming a primary winding and a secondary winding to each other.

2. The equalizer according to claim 1, further comprising a plurality of first conductor devices, which are coupled with said switch means in parallel separately.

3. The equalizer according to claim 1, further comprising a second conductor device, which is coupled with said secondary winding.

4. The equalizer according to claim 1, wherein the polarity of said secondary winding is opposite to said primary winding.

5. The equalizer according to claim 1, wherein each of said plurality of switch devices is a three-terminal device.

6. The equalizer according to claim 5, wherein said three-terminal device is a metal oxide semiconductor field effect transistor (MOSFET).

7. The equalizer according to claim 2, wherein each of said plurality of first conductor devices is said three-terminal device.

8. The equalizer according to claim 7, wherein said three-terminal device is a metal oxide semiconductor field effect transistor (MOSFET).

9. The equalizer according to claim 2, wherein each of said plurality of first conductor devices is a two-terminal device.

10. The equalizer according to claim 9, wherein said two-terminal device is a diode device.

11. The equalizer according to claim 3, wherein said second conductor device is the same as said first conductor device.

12. The equalizer according to claim 6, wherein said plurality of first conductor devices are internal parasitic devices of metal oxide semiconductor field effect transistors (MOSFETs).

13. The equalizer according to claim 1, wherein said plurality of switch devices are driven by the control signals separately.

14. An equalizer of connected battery strings, comprising:
a series of connected battery string apparatus, which is comprising a plurality of series of batteries, wherein one end of said series of connected battery string apparatus being coupled with the positive terminal of a current source, and the other end of said series of connected battery string apparatus being coupled with the negative terminal of said current source;
a battery voltage sensing and controlling apparatus, comprising a plurality of high frequency signal output ports and a plurality of input ports, wherein said plurality of input ports being coupled with said plurality of batteries separately;
an equalizer, comprising:
a transformer, which is constituted by a primary winding and a secondary winding, said primary winding being constituted by a plurality of windings with the identical number of windings and the identical polarity, the number of windings of said secondary winding being identical to the sum of the number of windings of said primary winding; and
a switch means, which is constituted by a plurality of switch devices, each of said switch devices of said switch means being coupled with said plurality of windings and said plurality of high frequency signal output ports in identical polarity in said primary winding; wherein
when said plurality of switch devices being driven by a high frequency control signal simultaneously from said battery voltage sensing and controlling apparatus, then said plurality of windings in said primary winding becoming a primary winding and a secondary winding to each other.

15. The equalizer of connected battery strings according to claim 14, further comprising a plurality of first conductor devices, which are coupled with said switch means in parallel individually.

16. The equalizer of connected battery strings according to claim 14, further comprising a second conductor device, which is coupled with said secondary winding.

17. The equalizer of connected battery strings according to claim 14, wherein the polarity of said secondary winding is opposite to said primary winding.

18. The equalizer of connected battery strings according to claim 14, wherein each of said plurality of switch devices is a three-terminal device.

19. The equalizer of connected battery strings according to claim 18, wherein said three-terminal device is a metal oxide semiconductor field effect transistor (MOSFET).

20. The equalizer of connected battery strings according to claim 15, wherein each of said plurality of first conductor devices is said three-terminal device.

21. The equalizer of connected battery strings according to claim 20, wherein said three-terminal device is a metal oxide semiconductor field effect transistor (MOSFET).

22. The equalizer of connected battery strings according to claim 15, wherein each of said plurality of first conductor devices is a two-terminal device.

23. The equalizer of connected battery strings according to claim 22, wherein said two-terminal device is a diode device.

24. The equalizer of connected battery strings according to claim 16, wherein said second conductor device is the same as said first conductor device.

25. The equalizer of connected battery strings according to claim 14, wherein said high frequency signal outputted from said battery voltage sensing and controlling means is a Pulse-Width-Modulated (PWM) signal.

26. The equalizer of connected battery strings according to claim 14, wherein said battery voltage sensing and controlling means is a micro-controller.

27. The equalizer of connected battery strings according to claim 14, wherein said plurality of switch devices are driven by the high frequency signals outputted from said battery voltage sensing and controlling means separately.

28. The equalizer of connected battery strings according to claim 14, wherein said current source is a direct current source.

29. The equalizer of connected battery strings according to claim 14, wherein said equalizer is able to equalize indefinite numbers of battery by selecting in said series of connected battery string by the different connections between said equalizer and said series of connected battery string.
